(19) United States
(12) Patent Application Publication
(10) Pub. No.: US 2013/0177750 A1
(43) Pub. Date: Jul. 11, 2013

(54) Fiber-Reinforced Impact Resistant Laminated Panel

(71) Applicant: Panolam Industries International, Inc, Shelton, CT (US)

(72) Inventor: Stephen Canary, Westfield, MA (US)

(73) Assignee: PANOLAM INDUSTRIES INTERNATIONAL, INC, Shelton, CT (US)

(21) Appl. No.: 13/739,757

(22) Filed: Jan. 11, 2013

Related U.S. Application Data
(60) Provisional application No. 61/585,480, filed on Jan. 11, 2012.

(51) Int. Cl. B32B 7/02

(52) U.S. Cl. CPC B32B 7/02
USPC 428/212; 428/532; 442/181

(57) ABSTRACT

An impact resistant laminated panel and a method for making the same is provided. The panel includes in stacked order: a first side overlay layer, a decorative layer, a first side fiber-reinforced layer, a core layer, a second side fiber-reinforced layer, and a base layer. The decorative layer has at least one appearance sheet and at least one flattening sheet. The flattening sheet is disposed between the appearance sheet and the first side fiber-reinforced layer. The decorative layer has a sufficient mass to prevent the formation of surface flatness and/or appearance variations in the outer surface of the first side overlay layer, which variations are attributable to the first side fiber-reinforced sheet.

This application claims the benefit of U.S. Provisional Patent Application Ser. No. 61/585,480, filed Jan. 11, 2012, which is hereby incorporated in its entirety.

### BACKGROUND OF THE INVENTION

1. Field of the Invention

The present invention relates to decorative laminated panels in general and, more particularly, to laminated panels having fiber-reinforced layers and methods for manufacturing the same.

2. Background Information

High pressure decorative laminated panels are often used in the construction of kitchen and bath cabinetry, furniture, store fixtures and other building products. Heat and pressure consolidated decorative laminated panels are generally produced utilizing a core material comprising a plurality of phenolic resin impregnated kraft paper sheets, a decorative sheet impregnated with a melamine-formaldehyde resin and optionally a melamine resin impregnated overlay sheet. These high pressure laminated panels, examples of which are described in U.S. Pat. No. 3,418,189 to Grosheim et al., U.S. Pat. No. 4,311,748 to Casey et al., and U.S. Pat. No. 4,473,613 to Jaisle et al., have found world-wide acceptance as construction materials, i.e., wall panels, countertops, etc. in the home and office.

The above-described high-pressure laminated panels are typically brittle, have limited impact resistance, and are susceptible to mechanical failure as a result of flexure. These mechanical property limitations are not an issue if the laminated panel is attached to a rigid substrate and not subject to flexure. If a prior art laminated panel is subjected to flexure in a manner diagrammatically illustrated in FIGS. 1A-1C, however, the outer most portions of the laminated panel proximate the bottom and top surfaces are alternately exposed to compression and tension forces; e.g., as the panel is impacted and subsequently rebounds. Specifically, FIG. 1A shows an undeflected panel 2. FIG. 1B shows the panel 2 deflected such that at least a portion of the top surface 3 is subject to compressive forces, and at least a portion of the bottom surface 4 is in subject to tensile forces. FIG. 1C shows the panel 2 deflected in the opposite direction such that at least a portion of the top surface 3 is subject to tensile forces, and at least a portion of the bottom surface 4 is in subject to compressive forces. If the magnitude and/or frequency of the deflection is great enough, eventually cracks will likely form and propagate in the outermost portions of the laminated panel. The cracks, in turn, weaken the laminated panel's ability to withstand the flexure and the failure mode increases as the number of cracks increase.

Modern bowling alleys often utilize laminated panels to form the “working surface” of the bowling alley; i.e., the upper exposed panel that the bowling balls contact. Laminated panels used in bowling alley applications, and in particular those used as lane sections proximate the “user” end of the lane, are subject to constant impact and flexure as a result of the heavy bowling balls being thrown into contact with the lane. In many instances, bowling alleys that include a laminated upper panel will eventually be subject to the above-described cracking in the outer-most portions of the laminated panel; particularly the outer most portion of the panel proximate the bottom surface of the laminated panel. Eventually, the cracking compromises the laminated panel (and therefore the bowling alley lane) and necessitates replacement.

What is needed is a laminated panel that resists cracking that results from flexure of the panel, one that has a desirable level of impact resistance, and one that can be used in a bowling alley application.

### SUMMARY OF THE INVENTION

According to an aspect of the present invention, an impact resistant laminated panel consolidated at elevated temperature and pressure is provided. The laminated panel includes in stacked order: a first side overlay layer, a decorative layer, a first side fiber-reinforced layer, a core layer, a second side fiber-reinforced layer, and a base layer. The first side overlay layer has an outer surface. The decorative layer has at least one appearance sheet and at least one flattening sheet. The flattening sheet is disposed between the appearance sheet and the first side fiber-reinforced layer. The decorative layer has a sufficient mass to prevent the formation of surface flatness and/or appearance variations in the outer surface of the first side overlay layer, which variations are attributable to the first side fiber-reinforced sheet. The first side fiber-reinforced layer has a textured outer surface that is contiguous with the decorative layer. The first side fiber-reinforced layer includes at least one fiber-reinforced sheet, which is substantially devoid of cellulose. The core layer includes a plurality of cellulosic sheets.

According to another aspect of the present invention, a method of producing an impact resistant laminated panel is provided. The method includes the steps of: a) stacking in a superimposed order a first side overlay layer, having an outer surface, a decorative layer, a first side fiber-reinforced layer, having a textured outer surface that is contiguous with the decorative layer, which first-side fiber-reinforced layer includes at least one fiber-reinforced sheet, which is substantially devoid of cellulose, and wherein the decorative layer has at least one appearance sheet and at least one flattening sheet, which flattening sheet is disposed between the appearance sheet and the first side fiber-reinforced layer, and which decorative layer has a sufficient mass to prevent the formation of surface flatness and/or appearance variations in the outer surface of the first side overlay layer, which variations are attributable to the first side fiber-reinforced sheet, a core layer comprising a plurality of cellulosic sheets, a second side fiber-reinforced layer, and a base layer; and b) simultaneously curing, under elevated heat and pressure, the first side overlay layer, the decorative layer, the first side fiber-reinforced layer, the core layer, the second side fiber-reinforced layer, and the base layer to produce the fiber-reinforced laminated panel.

An advantage of the present invention is that it provides a laminate having desirable impact-resistance and durability characteristics. As used herein, the term “impact-resistant” or “impact resistance” refers to the ability to withstand relatively low-energy and/or low-speed blunt objects impinging or striking the surface of the structure with no appreciable damage. The present laminated panel has a layer configuration that resists the formation of cracks radiating from the point of impact and damage to the panel proximate the point of impact. In fact, test comparisons between an embodiment of the present laminated panel versus the same panel less the fiber-reinforced layers, each stacked as described herein, revealed a better than 50% increase in impact resistance and a better than 20% increase in flexural strength.

These and other features and advantages of the present invention will become apparent in light of the drawings and detailed description of the present invention provided below.

### DESCRIPTION OF THE DRAWINGS

FIGS. 1A-1C are diagrammatic illustrations of a planar panel, and the same panel deflecting in two opposite vertical directions.

FIG. 2 is a diagrammatic representation of an embodiment of the present invention laminated product.

FIG. 3 is a diagrammatic representation of an embodiment of the present invention laminated product.

FIG. 4 is a diagrammatic representation of an embodiment of a laminated panel, illustrating a textured top surface having a plurality of depressions and raised areas.

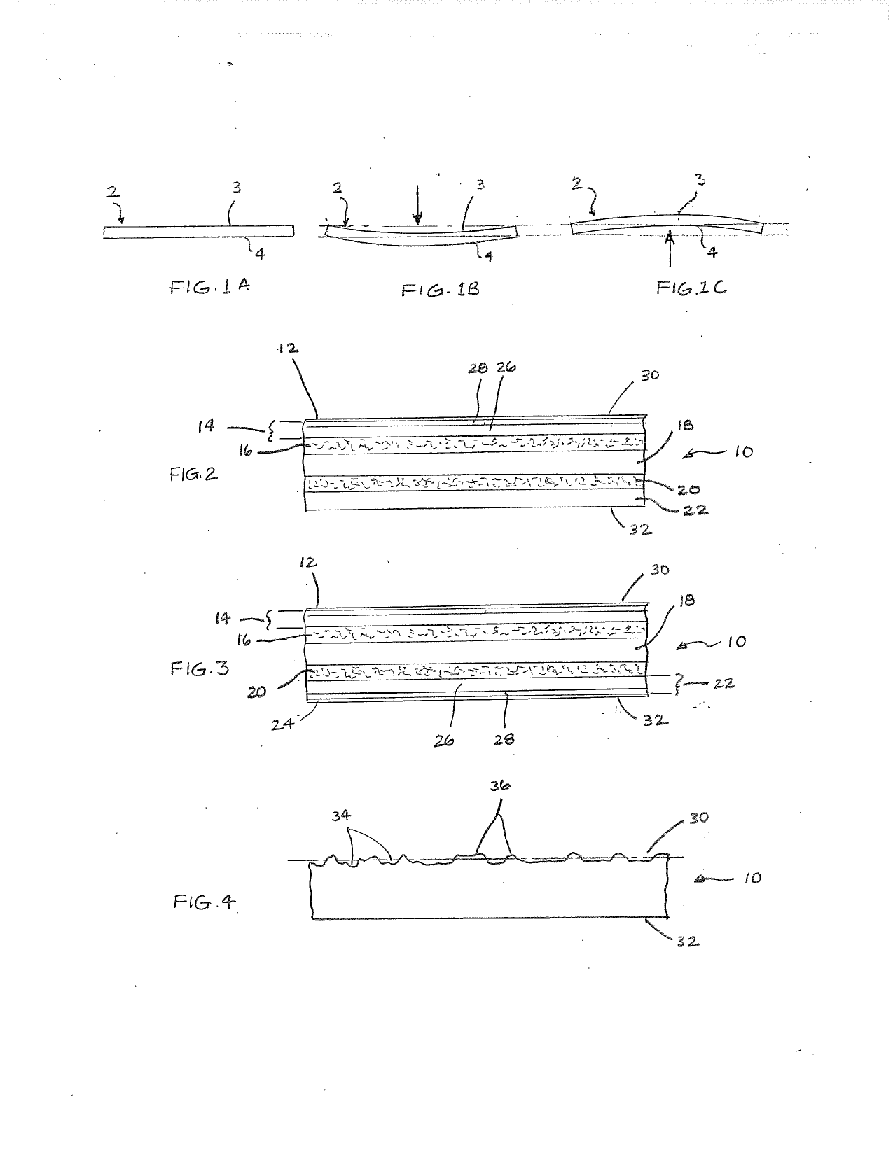

### DETAILED DESCRIPTION OF THE INVENTION

Now referring to FIGS. 2 and 3, the present high impact resistance laminated panel 10 includes the following layers arranged in superimposed order (which may also be referred to as a “stacked” order): a first side overlay layer 12; a decorative layer 14; a first side fiber-reinforced layer 16; a core layer 18 comprising a plurality of cellulosic sheets; a second side fiber-reinforced layer 20; and a base layer 22. In some embodiments, the laminated panel 10 may also include a second side overlay layer 24 disposed outside of the base layer 22. As used herein, the term “layer” is used to mean a portion of the laminate having certain characteristics (described herein), which portion includes at least one sheet. As used herein, the term “sheet” generally means a thin, distinct ply. A cellulosic sheet includes any thin layer formed substantially of plant fibers or processed plant fibers, for example, paper, alpha-cellulose, or linter products.

The first side overlay layer 12 includes one or more cellulosic sheets; e.g., alpha-cellulosic sheets. The overlay layer 12 may be impregnated with a resin. For example, the overlay layer 12 may be formed of high-quality alpha-cellulose paper impregnated with a thermosetting resin. Typically, the alpha-cellulose paper acts as a translucent (e.g., essentially transparent) carrier for the resin, imparts strength to the resin, facilitates maintaining a uniform resin thickness, and provides a measure of abrasion resistance to the decorative layer 14. An example of an acceptable cellulosic sheet for use in the first side overlay layer 12 is alpha cellulose paper having a basis weight in the range of 20-50 g/m², impregnated with a melamine resin. The overlay layer 12 may include abrasive particles (e.g., aluminum oxide) to impart increased abrasion resistance to the layer. The amount and size of the particles within the overlay can be controlled to provide a desired coefficient of friction on the surface. In those embodiments wherein the overlay layer 12 includes more than one cellulosic sheets, the different sheets may provide different functions; e.g., a first sheet having a first basis weight that is operable to act as a gloss layer, and a second sheet having a second basis weight (greater than that of the first sheet) that is operable to act as a high wear layer.

The decorative layer 14 includes a plurality of sheets, including at least one flattening sheet 26, and at least one appearance sheet 28. The appearance sheet is disposed outside of the flattening sheet 26 (i.e., between the respective overlay layer and the flattening sheet), and has a color and/or a printed (or otherwise applied) design that is visible and gives the laminated panel 10 its appearance. The appearance sheet 28 may be a cellulosic sheet, or alternatively may be formed from fabrics, polymeric sheets, such as a polyester non-woven, and any other continuous, discontinuous or particulate material, or combination of materials, capable of imparting a color or design to the finished laminated panel 10. In those embodiments where the appearance sheet is formed from one or more cellulosic sheets, an acceptable cellulosic sheet is one having a basis weight in the range of 70-90 g/m², which may be impregnated with resin. The flattening sheet 26 is made of a cellulosic material. An example of a material that can be used as an acceptable flattening sheet 26 is kraft paper having a basis weight in the range of 240-260 g/m², impregnated with a phenolic resin. The decorative layer 14 (i.e., the combined sheets that collectively form the decorative layer 14) has a mass that is sufficient to distribute the elevated pressure load applied during formation of the laminated panel 10 to prevent the formation of surface flatness and/or appearance variations in the outer surface of the first side overlay layer 12, which variations are attributable to the first side fiber-reinforced layer 16 (as will be described below) and are perceivable by one or both of unaided human eye or touch. An example of a flatness and/or appearance variation that can be perceived is a variation in the gloss of the surface of the laminate. A difference of approximately five gloss units measured at a sixty degree (60°) angle is perceivable variation. The present decorative layer may be described, therefore, as a “barrier” that prevents the flatness and/or appearance variations attributable to the first side fiber-reinforced layer 16 from telegraphing through to the outer surface of the overlay layer 12. The number of flattening sheets 26 (and appearance sheets 28 in some applications) included within the decorative layer 14 can be varied depending upon the magnitude of the flatness and/or appearance variations in outer surface of the first side fiber-reinforced layer 16; e.g., the number of flattening sheets 26 within the decorative layer 14 is dictated by the number necessary to prevent the flatness and/or appearance variations from telegraphing through to the outer surface of the laminated panel 10—i.e., the outer surface of the overlay layer 12. The decorative layer 14 may be impregnated, fully or partially, with a thermosetting resin.

The first side fiber-reinforced layer 16 includes at least one fiber-reinforced sheet, which is substantially devoid of cellulose. The use of the phrase “substantially devoid of cellulose” means that the product (e.g., a sheet) may contain some minor amount of plant fiber, but the majority of the product, by weight, is composed of non-plant fiber materials, and to the extent that there may be plant fiber present, that plant fiber does not significantly affect the material properties of the product. The one or more fiber-reinforced sheets may be made of glass, carbon, aramid, boron, and/or other known synthetic reinforcing fibers. Each fiber-reinforced sheet may be a woven or non-woven sheet, or as an assemblage (e.g., a mat) of continuous or discontinuous fibers. The first side fiber-reinforced layer 16 may be impregnated with a thermosetting resin or a thermoplastic resin. The resin may be partially cured prior to the inclusion of the first side fiber-reinforced layer 16 within the stack-up that is consolidated into the present laminated panel 10.

It is our finding that a fiber-reinforced sheet having a basis weight in the range of 170-210 g/m² with a phenolic resin content of 35-45% of the dry treated basis weight of the same, disposed in the described configuration of the present laminated panel 10 creates a panel with desirable stiffness and impact resistance, and consequent durability. The “g/m²” designation refers to the weight of the sheet in grams per meter squared, for an industry standard sheet thickness, which weight changes depending upon the degree of resin saturation within the sheet. For present laminated panels 10 configured for use in bowling lane applications, it is our finding that fiber-reinforced layers (e.g., woven fiberglass) having a basis weight in the range of 185-195 g/m² with a phenolic resin content of about 40% of the dry treated weight provides particularly desirable impact resistance and durability. In fact, test comparisons between an embodiment of the present laminated panel 10 versus the same panel less the fiber-reinforced layers, each stacked as described herein, revealed a better than 50% increase in impact resistance and a better than 20% increase in flexural strength. The significantly improved impact resistance and increase in flexural strength is believed to be attributable to several factors, including: a) the particular arrangement of layers (i.e., the stack up) within the present laminated panel 10; b) the positional symmetry of the fiber-reinforced layers 16,20 within the present laminated panel 10 relative to the core layer 18 and outer surfaces 30, 32 of the laminated panel 10, and the “closeness” of each fiber-reinforced layer to the respective outer surface 30,32 of the laminated panel 10; and c) the basis weight of the fiber-reinforced sheet(s) 16,20 within the fiber-reinforced layer.

The surface of the first side fiber-reinforced layer 16 that is contiguous with the decorative layer 14 typically has a texture. The term “texture” is used to describe that the surface of a layer is not flat, and has surface variations (e.g., depressions and raised areas) that dip below or rise above a straight line representative of the average surface position as is shown diagrammatically in FIG. 4. In FIG. 4, the phantom line illustrates the position of a flat top surface 30 of a laminated panel 10. The top surface shown in FIG. 4 (exaggerated to illustrate the point) is not flat, but rather includes multiple depressions 34 and raised areas 36. The texture of a woven fiber-reinforced layer, for example, typically reflects the weave of fibers used to create the layer, and may also reflect the surface characteristics of the fibers themselves. The surface variations 34,36 of a textured fiber-reinforced layer can in most instances be felt by hand, and/or seen by human eye.

The core layer 18 comprises a plurality of cellulosic sheets, each at least partially impregnated with a thermosetting resin. An example of an acceptable cellulosic sheet for use in the core layer 18 is kraft paper having a basis weight in the range of 240-260 g/m². An example of a thermosetting resin impregnated into the kraft paper is a phenolic resin. The number of sheets within the core layer 18 can be manipulated to produce a laminated panel 10 of a predetermined thickness.

The second side fiber-reinforced layer 20 is formed of the same materials as those described above with respect to the first side fiber-reinforced layer 16. In some laminated panel 10 embodiments, the second side fiber-reinforced layer 20 may be formed from the exact same materials as the first side fiber-reinforced layer 16. In other laminated panel 10 embodiments, the second side fiber-reinforced layer 20 may be formed from a material that is different from that used in the first side fiber-reinforced layer 16, but still a material that could be used as described above under the description of the first side fiber-reinforced layer 16.

The base layer 22 includes one or more sheets that provide mechanical properties similar or the same as those provided by the decorative layer 14, thereby providing symmetry to the laminated panel 10 stack; e.g., core layer 18 at the center; first and second fiber-reinforced layers 16,20 outside of the core layer 18; and the decorative layer 14 and base layer 22 outside of the fiber-reinforced layers 16,20. The similar mechanical properties of the decorative layer 14 and the base layer 22 offset any tendency that might exist for the laminated panel 10 to warp; e.g., as a result of surface tensions, etc. In some embodiments, the base layer 22 may comprise the exact same configuration as the decorative layer 14; e.g., at least one cellulose flattening sheet 26 and at least one appearance sheet 28. This arrangement is particularly useful if the top surface 30 and bottom surface 32 of the laminated panel 10 are both visible, or if the panel 10 is configured to permit use of both the top and bottom surfaces 30,32. In those embodiments where just the top surface 30 of the laminated panel 10 (e.g., the outer surface of the overlay layer) is intended to be exposed, then it may be desirable to use alternative materials within the base layer 22; e.g., materials that are less expensive, and/or easier to handle during the laminated panel 10 production.

In some embodiments, the laminated panel 10 may further include a second side overlay layer 24 disposed outside of the base layer 22. For example, in those embodiments where the base layer 22 is the same as the decorative layer 14 and the laminated panel 10 is configured to allow use of both the top and bottom surfaces, it may be desirable to include a second side overlay layer 24 outside the base layer 22 to protect the base layer 22 and provide the laminated panel 10 with two similar surfaces.

A first process of manufacturing the present fiber-reinforced decorative laminated panel involves stacking a first side overlay layer 12, a decorative layer 14, a first side fiber-reinforced layer 16, a core layer 18, a second side fiber-reinforced layer 20, and a base layer 22 in a superimposed order (i.e., a “build-up”) between caul plates. As indicated above in some embodiments, a second side overlay layer 24 is disposed outside of the base layer 22. The build-up is then subjected to a predetermined pressure and temperature (higher than ambient) for a time sufficient for resin with the various layers to migrate within the stack of layers, cure, and thereby consolidate the respective layers into a laminated panel 10. Once the build-up has consolidated at the aforesaid pressure and temperature into the laminated panel 10, the panel is subsequently cooled to a predetermined temperature while remaining at an elevated pressure. Cooling the laminated panel 10 under pressure until a predetermined temperature is reached greatly decreases the propensity of the laminated structure to warp.

A second process for manufacturing the present fiber-reinforced decorative laminated panel 10 involves continuously, or semi-continuously, supplying to a continuous press the following layers in the aforesaid superimposed order, from sources upstream of the continuous press: a first side overlay layer 12, a decorative layer 14, a first side fiber-reinforced layer 16, a core layer 18, a second side fiber-reinforced layer 20, and a base layer 22. As indicated above in some embodiments, a second side overlay layer 24 is disposed outside of the base layer 22. The continuous press is configured to create the temperature and pressure environment required to consolidate the layers into the finished laminated panel. The line speed of the continuous press is chosen to create a dwell time within the press that is adequate to ensure sufficient consolidation of the various layers as described above. A release sheet may be disposed on each side of the build-up prior to entering the press. The release sheets are typically drawn off after the laminated panel exits the press. The continuous press may be advantageous because it decreases the processing time of the laminated panel, although use of the continuous press requires that the sheets fed into the press be continuous (or semi-continuous) and have a certain measure of handleability. Once the layers have consolidated within the continuous press into a laminated panel 10, the laminated panel 10 is subsequently cooled to a predetermined temperature while remaining at an elevated pressure. Cooling the laminated panel 10 under pressure greatly decreases the propensity of the laminated panel 10 to warp.

In both of the above-described manufacturing processes, the elevated temperature and pressure causes the resins impregnated within the layers to migrate within and between the layers, allowing the layers to consolidate and form the laminated panel 10. In the discontinuous (or “batch”) press laminating process, the present laminated panel 10 would generally be processed at a temperature in the range from about 110° C. to about 170° C., at a pressure within the range of about 500 psi to about 1600 psi, and subsequently cooled under a pressure within the aforesaid range until the laminated panel 10 reached a temperature of between about 40° C. to about 80° C. In the continuous press laminating process, the present invention would generally be processed at a temperature above about 120° C. (with the temperature range depending on the dwelling time of the laminated structure in the press), at a pressure within the range of about 300 psi to about 1000 psi, and subsequently cooled under pressure within the aforesaid range by passage between and/or around cooling rolls to a temperature of between about 40° C. to about 80° C. Curing temperatures and pressures are typically selected based on the specific resin in use and the ultimate desired properties of the cured laminated structure. Curing temperatures can also be manipulated to suit the speed of the process; e.g., higher curing temperatures can be used at higher processing speeds and lower curing temperatures can be used at lower processing speeds.

In some embodiments, the cured decorative laminated structure described above is designed to be subsequently attached to another structure. For example, the decorative laminated structure can be adhesively or mechanically fastened to cargo-carrying products or to walls in high-traffic corridors to provide protection from impact or other damage. As another example, the decorative laminated structure 10 can be permanently or removably attached to a finished piece of furniture in an after-market situation.

The following examples are illustrative of the inventive decorative laminated structure and do not constitute any limitation with regard to the subject matter of the invention:

### Example I

A decorative laminated panel 10 is produced using a non-continuous press. A build-up consisting of a first side overlay layer 12, a decorative layer 14, a first side fiber-reinforced layer 16, a core layer 18, a second side fiber-reinforced layer 20, and a base layer 22 is made in a superimposed order and placed between steel caul plates. Release sheets may be positioned on either side of the stack to facilitate the laminating process, but do not form part of the laminated panel 10. The overlay layer 12 includes two different sheets of alpha-cellulose paper impregnated with a thermosetting resin; e.g., a first alpha cellulose paper having a basis weight of about 24 g/m², and a second alpha cellulose paper having a basis weight of about 45 g/m². Both alpha cellulose sheets are impregnated with a melamine resin. The decorative layer 14 includes an appearance sheet 28 having a solid color and/or a printed pattern, impregnated with melamine resin, and three flattening sheets 26, each consisting of kraft paper having a basis weight of about 250 g/m² impregnated with a phenolic resin. The first side fiber-reinforced layer 16 is a single sheet of woven fiberglass having a basis weight of about 190 g/m² with a phenolic resin content of about 40% of the dry treated weight of the sheet. The core layer 18 includes thirty-two (32) sheets of kraft paper having a basis weight of about 250 g/m² impregnated with a phenolic resin. The number of sheets within the core layer 18 is related to the desired thickness of the laminated panel 10. In this example, the described stack-up of layers creates a laminated panel 10 having a thickness of approximately 0.375 inches (i.e., ⅜″ or 9.525 mm) In those embodiments where the texture of the fiber-reinforced layer 16 is great enough so that more than the above-described three flattening sheets 26 are needed to eliminate the flatness variations in the outer surface 30,32 of the laminated panel 10, one or more of the sheets within the core layer 18 can be shifted to the decorative layer 14 to create the desired flat outer surface and still maintain the overall thickness of the laminated panel 10. The second side fiber-reinforced layer 20 consists of the same material as the first side fiber-reinforced layer 16. The base layer 22 includes a number of sheets of kraft paper that gives the base layer 22 approximately the same mechanical properties as the above-described decorative layer 14.

The stack of layers is disposed between the caul plates of a batch-type press and is subjected to a pressure of about 1100 psi. Once the predetermined pressure is reached, the press is heated to a predetermined temperature of about 140° C. The press is held at the aforesaid pressure and temperature for a heating cycle of about 10 minutes. The pressed laminate panel 10 is then cooled in the press under the same pressure until the laminated panel 10 reaches a temperature of 60° C. or less. The pressure is then released and the fiber-reinforced decorative laminated panel 10 is removed from the press. The resulting laminate is approximately 0.375 inches (9.525 mm) thick. Cooling the laminated panel 10 in the press under pressure desirably increases the flatness of the final panel 10.

### Example II

The fiber-reinforced decorative laminated structure is manufactured using a GreCon continuous high pressure laminating press, which includes an inlet section, a heating section and a cooling section. The cooling section includes a plurality of rolls. The temperature of each section is controlled independently. The total amount of heat imparted to the layers of the build-up is controlled by the temperature of the different sections and the dwell time, which is dependent on the line speed. This continuous process requires that the various sheets (described above in Example I) used to manufacture the laminate panel 10 be fed into the continuous press as continuous webs from positions upstream of the continuous press in a manner that permits the various sheets to continuously enter the press in the aforesaid superimposed order. The temperature settings of the different press sections are as follows: the inlet section is set at approximately 200° C., the heating section is set at approximately 185° C., and the cooling section is set at approximately 15° C. The pressure in all sections may be set at about 350 psi. The line speed of the continuous press is set at about 5 ft/min to create a dwell time within the press of approximately 2.4 minutes.

It will be obvious to those skilled in the art that various changes may be made without departing from the scope of the present invention and that the invention is not to be considered limited to what is described and exemplified in the specification.

What is claimed is:

1. An impact resistant laminated panel consolidated at elevated temperature and pressure, which laminated panel comprises in stacked order:
a first side overlay layer, having an outer surface;
a decorative layer;
a first side fiber-reinforced layer, having a textured outer surface that is contiguous with the decorative layer, which fiber-reinforced layer includes at least one fiber-reinforced sheet, which is substantially devoid of cellulose;
wherein the decorative layer has at least one appearance sheet and at least one flattening sheet, which flattening sheet is disposed between the appearance sheet and the first side fiber-reinforced layer, and which decorative layer has a sufficient mass to prevent the formation of surface flatness variations in the outer surface of the first side overlay layer, which flatness variations are attributable to the first side fiber-reinforced sheet and are perceivable by one or both of unaided human eye or touch;
a core layer comprising a plurality of cellulosic sheets;
a second side fiber-reinforced layer; and
a base layer.

2. The laminated panel of claim 1, wherein the first side fiber-reinforced layer includes one or more sheets of woven fiberglass having a basis weight in the range of 170-210 g/m².

3. The laminated panel of claim 2, wherein the first side fiber-reinforced layer includes one or more sheets of woven fiberglass having a basis weight of about 190 g/m².

4. The laminated panel of claim 2, wherein each sheet of woven fiberglass has a phenolic resin content of about 40% of a dry treated basis weight of the sheet.

5. The laminated panel of claim 2, wherein the cellulosic sheets of the core layer comprise kraft paper having a basis weight in the range of 240-260 g/m².

6. A method of producing an impact resistant laminated panel, the method comprising the steps of:
stacking in a superimposed order a first side overlay layer, having an outer surface, a decorative layer, a first side fiber-reinforced layer, having a textured outer surface that is contiguous with the decorative layer, which first-side fiber-reinforced layer includes at least one fiber-reinforced sheet, which is substantially devoid of cellulose, and wherein the decorative layer has at least one appearance sheet and at least one flattening sheet, which flattening sheet is disposed between the appearance sheet and the first side fiber-reinforced layer, and which decorative layer has a sufficient mass to prevent the formation of one or both of surface flatness variations and surface appearance variations in the outer surface of the first side overlay layer, which variations are attributable to the first side fiber-reinforced sheet and are perceivable by one or both of unaided human eye or touch, a core layer comprising a plurality of cellulosic sheets, a second side fiber-reinforced layer, and a base layer; and
simultaneously curing, under heat and pressure, the first side overlay layer, the decorative layer, the first side fiber-reinforced layer, the core layer, the second side fiber-reinforced layer, and the base layer to produce the laminated panel.

7. The method of claim 6, wherein the first side fiber-reinforced layer includes one or more sheets of woven fiberglass having a basis weight in the range of 170-210 g/m².

8. The method of claim 7, wherein the first side fiber-reinforced layer includes one or more sheets of woven fiberglass having a basis weight of about 190 g/m².

9. The method of claim 7, wherein each sheet of woven fiberglass has a phenolic resin content of about 40% of a dry treated basis weight of the sheet.

10. The method of claim 7, wherein the cellulosic sheets of the core layer comprise kraft paper having a basis weight in the range of 240-260 g/m².
